(19) United States
(12) Patent Application Publication
(10) Pub. No.: US 2026/0113768 A1
(43) Pub. Date: Apr. 23, 2026

(54) DL PHASE NOISE MITIGATION FOR FDM OR SDM

(71) Applicant: QUALCOMM Incorporated, San Diego, CA (US)

(72) Inventor: Ronen SHAKED, Kfar Saba (IL)

(21) Appl. No.: 19/117,954

(22) PCT Filed: Nov. 20, 2023
(86) PCT No.: PCT/US2023/080510

§ 371 Date: Apr. 2, 2025

(30) Foreign Application Priority Data
Dec. 9, 2022 (IL) 298967

(51) Int. Cl. H04W 72/54

(52) U.S. Cl. CPC H04W 72/54

(57) ABSTRACT

A network node may transmit a frequency domain allocation map associated with one or more first UEs or first modulation order information associated with the one or more first UEs to a UE. The UE and the one or more first UEs may be associated with an FDM operation or an SDM operation. The UE may cancel inter-UE interference associated with the one or more first UEs and the FDM operation or the SDM operation based on the frequency domain allocation map or the first modulation order information. The inter-UE interference may be associated with a phase noise associated with the network node. The phase noise associated with the network node may be associated with an oscillator at the network node. The UE may cancel the inter-UE interference based on one or more ICI estimates.

### CROSS-REFERENCE TO RELATED APPLICATION

This application claims the benefit of Israel Patent Application Serial No. 298967, entitled “DL PHASE NOISE MITIGATION FOR FDM OR SDM” and filed on Dec. 9, 2022, which is expressly incorporated by reference herein in its entirety.

### TECHNICAL FIELD

The present disclosure relates generally to communication systems, and more particularly, to interference mitigation in a wireless communication system.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a user equipment (UE). The apparatus may receive a frequency domain allocation map associated with one or more first UEs or first modulation order information associated with the one or more first UEs from a network node. The UE and the one or more first UEs may be associated with a frequency division multiplexing (FDM) operation or a spatial division multiplexing (SDM) operation. The apparatus may cancel inter-UE interference associated with the one or more first UEs and the FDM operation or the SDM operation based on the frequency domain allocation map or the first modulation order information. The inter-UE interference may be associated with a phase noise associated with the network node.

In an aspect of the disclosure, a method, a computer-readable medium, and an apparatus are provided. The apparatus may be a network node. The apparatus may receive a request for inter-UE interference cancelation information from a UE. The apparatus may transmit, for the UE, a frequency domain allocation map associated with one or more first UEs or first modulation order information associated with the one or more first UEs based on the request for the inter-UE interference cancelation information. The UE and the one or more first UEs may be associated with an FDM operation or an SDM operation. The frequency domain allocation map or the first modulation order information may be associated with cancelation of inter-UE interference at the UE. The inter-UE interference may be associated with a phase noise associated with the network node.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example wireless communication system in which multiple UEs are served simultaneously based on FDM.

FIG. 5 is a diagram illustrating the inter-carrier interference (ICI) from neighbor UEs in connection with FDM.

FIG. 6 is a diagram illustrating an example wireless communication system in which multiple UEs are served simultaneously based on SDM.

FIG. 7 is a diagram of a communication flow of a wireless communication.

FIG. 8 is a flowchart of a method of wireless communication.

FIG. 9 is a flowchart of a method of wireless communication.

FIG. 10 is a flowchart of a method of wireless communication.

FIG. 11 is a flowchart of a method of wireless communication.

FIG. 12 is a diagram illustrating an example of a hardware implementation for an example apparatus and/or network entity.

FIG. 13 is a diagram illustrating an example of a hardware implementation for an example network entity.

### DETAILED DESCRIPTION

As the network node transmit (TX) phase noise level increases (e.g., due to a higher modulation order and/or a higher carrier frequency), the separation level of multiplexed users (e.g., based on FDM and/or SDM) may degrade. In other words, the UEs may no longer be sufficiently separated in the frequency domain and/or the space domain (for FDM and/or SDM, respectively) from one another. Instead, the UEs may experience significant inter-user leakage (also referred to hereinafter as inter-UE leakage). If left uncanceled or unmitigated, the inter-user leakage may generate an undesired interference floor, which may limit the system performance.

According to one or more aspects of the disclosure, a network node may transmit a frequency domain allocation map associated with one or more first UEs or first modulation order information associated with the one or more first UEs to a UE. The UE and the one or more first UEs may be associated with an FDM operation or an SDM operation. The UE may cancel inter-UE interference associated with the one or more first UEs and the FDM operation or the SDM operation based on the frequency domain allocation map or the first modulation order information. The inter-UE interference may be associated with a phase noise associated with the network node. Accordingly, a UE may be able to cancel inter-UE interference associated with the network node TX phase noise where an FDM operation or an SDM operation is used. Satisfactory system performance may be achieved, especially at higher carrier frequencies and/or higher modulation order.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

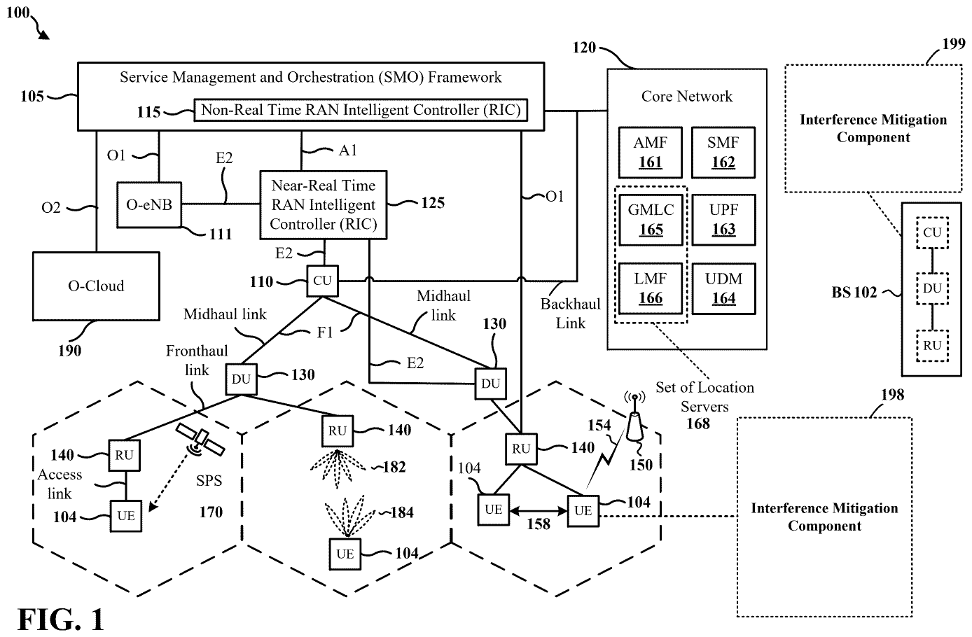

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FRI (410 MHZ-7.125 GHZ) and FR2 (24.25 GHz-52.6 GHZ). Although a portion of FR1 is greater than 6 GHz, FRI is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include an interference mitigation component 198 that may be configured to receive a frequency domain allocation map associated with one or more first UEs or first modulation order information associated with the one or more first UEs from a network node. The UE and the one or more first UEs may be associated with an FDM operation or an SDM operation. The interference mitigation component 198 may be configured to cancel inter-UE interference associated with the one or more first UEs and the FDM operation or the SDM operation based on the frequency domain allocation map or the first modulation order information. The inter-UE interference may be associated with a phase noise associated with the network node. In certain aspects, the base station 102 may include an interference mitigation component 199 that may be configured to receive a request for inter-UE interference cancelation information from a UE. The interference mitigation component 199 may be configured to transmit, for the UE, a frequency domain allocation map associated with one or more first UEs or first modulation order information associated with the one or more first UEs based on the request for the inter-UE interference cancelation information. The UE and the one or more first UEs may be associated with an FDM operation or an SDM operation. The frequency domain allocation map or the first modulation order information may be associated with cancelation of inter-UE interference at the UE. The inter-UE interference may be associated with a phase noise associated with the network node. Although the following description may be focused on 5G NR, the concepts described herein may be applicable to other similar areas, such as LTE, LTE-A, CDMA, GSM, and other wireless technologies.

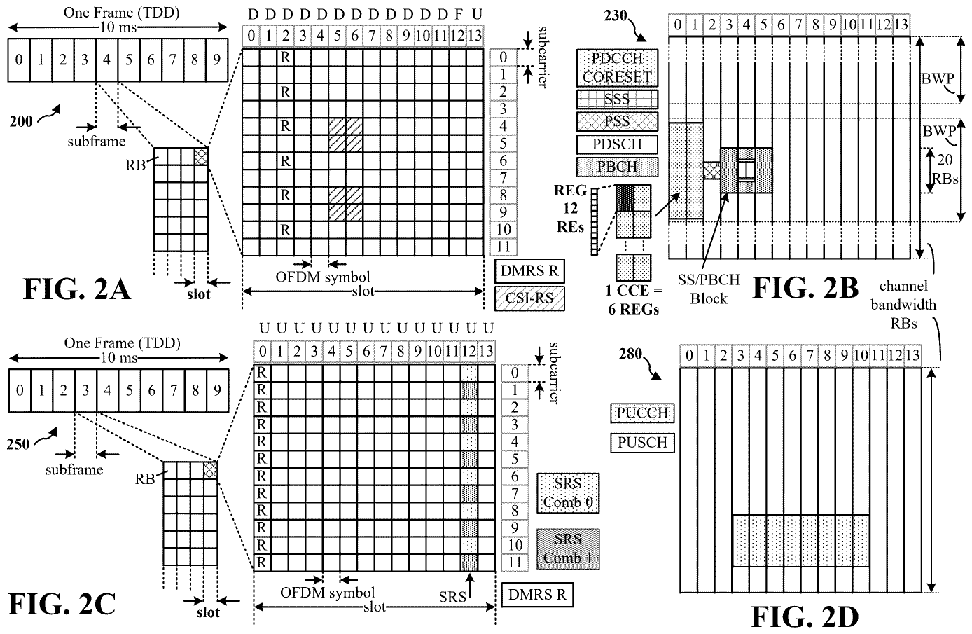

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

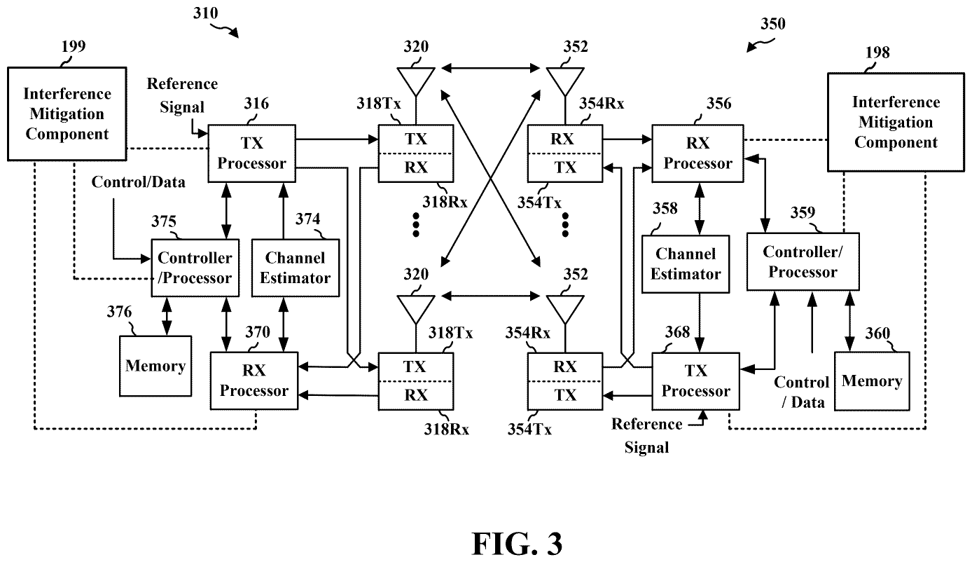

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the interference mitigation component 198 of FIG. 1.

At least one of the TX processor 316, the RX processor 370, and the controller/processor 375 may be configured to perform aspects in connection with the interference mitigation component 199 of FIG. 1.

The phase noise may be an inherent impairment of the oscillator used in the in-phase and quadrature (IQ) modulator. The phase noise may limit the link performance if it is left uncanceled. In millimeter wave (mmW) and more prominently in sub-THz bands, the number of antennas (or antenna elements) at devices may grow large, in order to achieve narrow beams that may compensates for the pathloss (which may be associated with the high carrier frequency). Based on the narrow beam transmission, a multiplexing (simultaneously serving multiple users) technique known as SDM may be implemented and used, where based on the SDM, different users (e.g., UEs) may be served simultaneously with different beams. In some scenarios, users (e.g., UEs) may share a same beam (e.g., the UEs may be in the vicinity of each other), and FDM may be used to serve these users simultaneously. Hence, FDM and/or SDM may become more prominent in future generation wireless communication systems (e.g., 5G, 6G, etc.).

Furthermore, the high carrier frequency of mmW and sub-THz bands may incur even higher oscillator-associated TX phase noise levels (e.g., the integrated phase noise (IPN)) at the network node (e.g., the base station, the TRP, etc.). Moreover, the higher modulation order (e.g., beyond 256QAM) (a modulation order may refer to the number of the different symbols that may be used in digital communication) commonly used together with the high carrier frequency may cause the phase noise to become the dominant floor that may need handling. The phase noise may become limiting if it is left uncanceled or unmitigated. For example, in mmW bands, the phase noise may be harsh (e.g., −28 dB), and in sub-THz bands, the phase noise may be even harsher (e.g., −23 dB). Accordingly, the phase noise may significantly limit the modulation order that may be used if it is left uncanceled or unmitigated.

In addition, as the network node TX phase noise level increases (e.g., due to a higher modulation order and/or a higher carrier frequency), the separation level of multiplexed users (e.g., based on FDM and/or SDM) may degrade. In other words, the UEs may no longer be sufficiently separated in the frequency domain and/or the space domain (for FDM and/or SDM, respectively) from one another. Instead, the UEs may experience significant inter-user leakage. If left uncanceled or unmitigated, the inter-user leakage may generate an undesired interference floor, which may limit the system performance.

According to one or more aspects, UEs served simultaneously based on FDM and/or SDM may be provided with assistance information to help the UEs to better cancel the network node TX phase noise. In particular, the network node may inform one or more UEs served simultaneously based on FDM and/or SDM of the frequency domain allocation map associated with the UEs and/or the modulation order associated with each of the UEs. In some configurations, the network node may provide the assistance information to a UE upon a request from the UE. UEs with the phase noise cancelation capability may benefit from the assistance information. Accordingly, such UEs may request the assistance information from the network node.

Accordingly, each of the UEs may perform not just self-phase noise suppression over its own signals but also cancelation of the interference from other UEs (the interference from other UEs may occur due to the phase noise). Without the assistance information, the UEs may not be able to fully suppress the phase noise because the UEs may not be able to cancel the inter-UE phase noise interference. If the inter-UE phase noise interference is left uncanceled or unmitigated, the system performance may suffer.

Based on the techniques disclosed herein, the residual suppressed phase noise floor may be further reduced. Accordingly, the wireless communication system performance may be improved, especially in sub-THz or mmW bands, where the higher carrier frequency may be associated with both the higher phase noise level and a higher modulation order. As a result, satisfactory FDM and/or SDM operation performance may be achieved despite the higher network node TX phase noise.

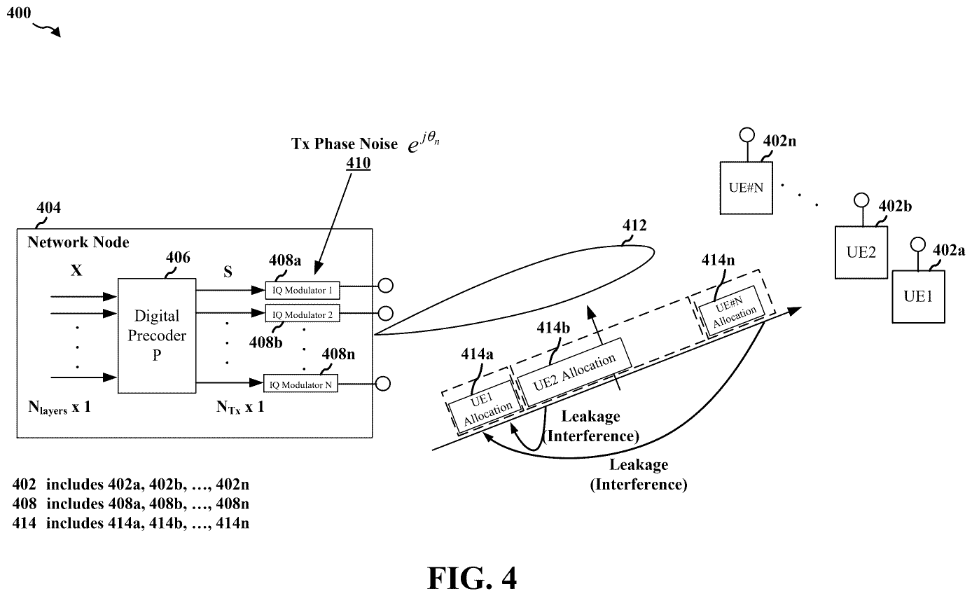

FIG. 4 is a diagram illustrating an example wireless communication system 400 in which multiple UEs are served simultaneously based on FDM. As shown, a network node 404 may serve multiple UEs 402 (including UE1 402a, UE2 402b, . . . , UE #N 402n) on a same beam 412 using FDM. In other words, each of the UEs 402 may be served using a separate frequency domain allocation 414 (e.g., frequency resources allocated to each of the UEs 402) (e.g., UE1 allocation 414a for UE1 402a, UE2 allocation 414b for UE2 402b, . . . , UE #N allocation 414n for UE #N 402n). The network node 404 may include a digital precoder 406 and a plurality of IQ modulators 408 (i.e., IQ modulator 1 408a, IQ modulator 2 408b, . . . , IQ modulator N 408n). The oscillator at the IQ modulators 408 may introduce the TX phase noise 410.

The phase noise in the transmitter of the network node 404 may be a multiplicative process in the time domain, i.e., sₙ·e^{jθ}^{ₙ}, which may be equivalent to cyclic convolution in the frequency domain, where the transmitted signal (for each lane on the N_{Tx}) may be Sₙ [symbol] Sₖ, and the time domain multiplicative noise process may translate to convolving the inter-carrier interference (ICI) coefficients in the frequency domain: e^{jθ}^{ₙ} [symbol] Iₖ. Accordingly,

$${S}_{[ k ]}^{( PNimpaired )} = {S}_{k} ⊗ {I}_{k} = {S}_{k} \cdot {I}_{0} + {S}_{k - 1} \cdot {I}_{1} + {S}_{k + 1} \cdot {I}_{- 1} + … ( ⊗ denoting convolution ) ,$$

where the part Sₖ·I₀ may correspond to the desired signal for the UE of interest, and the part Sₖ₋₁·I₁+Sₖ₊₁. I₋₁+ . . . may correspond to the ICI. At the center of the frequency domain allocation for the UE of interest, the ICI may be caused by the subcarriers for the UE of interest leaking into each other. The self-ICI may be canceled (de-ICI'ed) by the UE of interest using an iterative canceler as the modulation order of the UE of interest is known to the UE of interest. However, at the edge of the frequency domain allocation, there may be significant leakage from adjacent UEs into the UE of interest. For example, as shown in FIG. 4, UE1 402a may be the UE of interest. Signals for adjacent UEs including UE2 402b through UE #N 402n may leak into the frequency domain allocation 414a for UE1 402a. If the modulation orders of the adjacent UEs are not known to the UE of interest, the UE of interest may not be able to cancel the inter-UE interference associated with the leakage from the adjacent UEs. If the inter-UE interference is left untreated (uncanceled or unmitigated), the system performance may suffer.

Accordingly, in one or more aspects, the network node 404 may inform the UE of interest (e.g., UE1 402a) of the frequency domain allocation map (also referred to as the FDM allocation map) associated with the adjacent UEs (e.g., UE2 402b and UE #N 402n) (e.g., the information about the frequency resources allocated to the adjacent UEs) and the modulation order of each of the adjacent UEs (e.g., UE2 402b and UE #N 402n), such that the UE of interest (e.g., UE1 402a) may be enabled to perform inter-UE interference cancelation based on the frequency domain allocation map associated with the adjacent UEs and the modulation order of each of the adjacent UEs.

Because the instantaneous ICI coefficients Iₖ may be a Fourier transform of the phase noise process e^{jθ}^{ₙ}, by definition the average power of the ICI coefficients may fit the power spectral density (PSD) of the phase noise process. In other words, E|Iₖ|²=S_{θθ}(f=f_{sc}k). Therefore, the ICI coefficients may decay with frequency by nature. Consequently, the subcarriers that cause the most interference to the subcarrier of interest may be the subcarriers that are the most adjacent to the subcarrier of interest. The channel from the network node 404 to the UEs 402 at subcarrier k may be denoted as H_{[k]}. Accordingly, the precoded signal (e.g., at the output of the digital precoder 406) may be

$${S}_{k} = \{ \begin{matrix}{P}_{[ k ]} {\underline{x}}_{1 [ k ]} & k ∈ {UE}_{1} allocation \\ {P}_{[ k ]} {\underline{x}}_{2 [ k ]} & k ∈ {UE}_{2} allocation \\ … & \\ {P}_{[ k ]} {\underline{x}}_{N [ k ]} & k ∈ {UE}_{N} allocation\end{matrix} \} ,$$

where P_{[k]} may denote the precoding matrix coefficients for the subcarrier k.

In other words, the precoder may vary along the frequency domain. Further, UE1 402a may receive the vector of layers x_{1[k]} at the subcarrier k, UE2 402b may receive the vector of layers x_{2[k]} at the subcarrier k, and UE #N 402n may receive the vector of layers x_{N[k]} at the subcarrier k.

The precoder (e.g., the digital precoder 406) may be calculated per subcarrier (or based on a proportional rate greedy (PRG) algorithm) so that the precoder may provide the maximal energy transfer (or channel diagonalization): H_{[k]}P_{[k]}=max energy. Further, the network node 404 TX phase noise may impair the precoded signal:

$${S}_{[ k ]}^{( PNimpaired )} = {S}_{k} ⊗ {I}_{k} = {S}_{k} \cdot {I}_{0} + {S}_{k - 1} \cdot {I}_{1} + {S}_{k + 1} \cdot {I}_{- 1} + … .$$

Therefore, the received signal at the UEs 402 may be:

$${Y}_{[ k ]} = {H}_{[ k ]} \cdot {S}_{[ k ]}^{( PNimpaired )} = {H}_{[ k ]} ( {S}_{[ k ]} ⊗ {I}_{k} ) = {H}_{[ k ]} \{ ( \{ \begin{matrix}{P}_{[ k ]} {\underline{x}}_{1 [ k ]} & k ∈ {UE}_{1} allocation \\ {P}_{[ k ]} {\underline{x}}_{2 [ k ]} & k ∈ {UE}_{2} allocation \\ … & \\ {P}_{[ k ]} {\underline{x}}_{N [ k ]} & k ∈ {UE}_{N} allocation\end{matrix} \} ) ⊗ {I}_{k} \}$$

Hence, the received signal may experience cyclic convolution (e.g., x [k-r] may mean x[mod(k−r, N_{fft})]):

$${Y}_{[ k ]} = {H}_{[ k ]} ( \{ \begin{matrix}{\sum }_{r} {I}_{r} {P}_{[ k - r ]} {\underline{x}}_{1 [ k - r ]} & k ∈ {UE}_{1} allocation \\ {\sum }_{r} {I}_{r} {P}_{[ k - r ]} {\underline{x}}_{2 [ k - r ]} & k ∈ {UE}_{2} allocation \\ … & … \\ {\sum }_{r} {I}_{r} {P}_{[ k - r ]} {\underline{x}}_{N [ k - r ]} & k ∈ {UE}_{N} allocation\end{matrix} \} ) = \{ \begin{matrix}{\sum }_{r} {I}_{r} {H}_{[ k ]} {P}_{[ k - r ]} {\underline{x}}_{1 [ k - r ]} & k ∈ {UE}_{1} allocation \\ {\sum }_{r} {I}_{r} {H}_{[ k ]} {P}_{[ k - r ]} {\underline{x}}_{2 [ k - r ]} & k ∈ {UE}_{2} allocation \\ … & … \\ {\sum }_{r} {I}_{r} {H}_{[ k ]} {P}_{[ k - r ]} {\underline{x}}_{N [ k - r ]} & k ∈ {UE}_{N} allocation\end{matrix} \}$$

Accordingly, the observed signal for a UE #u0 may be Y_{[k]}=Σᵣ IᵣH_{[k]}P_{[k-r]}xᵤ_{ₒ}_{[k-r]}+Σ_{j≠u}_{ₒ}Σᵣ IᵣH_{[k]}P_{[k-r]}x_{j[k-r]}, where the part Σᵣ IᵣH_{[k]}P_{[k-r]}xᵤ_{ₒ}_{[k-r]} may correspond to the desired signal for UE #u0. UE #u0 may experience self-ICI, i.e., the subcarriers for UE #u0 may leak into the subcarrier k of interest. UE #u0 may be able to cancel the self-ICI because the modulation order of UE #u0 is known to UE #u0. Accordingly, an iterative demodulator may be used to remove/cancel the self-ICI.

Further, the part Σ_{j≠u}_{ₒ} Σᵣ IᵣH_{[k]}P_{[k-r]}x_{j[k-r]} may correspond to the inter-UE interference. Other UEs (e.g., UE #j where j≠u₀) may leak into the UE of interest UE #u0. The UEs that may cause the most interference may be the UEs that are adjacent to UE #u0: e.g., UE #u0−2, UE #u0−1, UE #u0+1, UE #u0+2, etc. For u0=1 (i.e., for UE #1), the UE of interest, UE #1, may be allocated with frequency resources at the edge of the spectrum, and the UE of interest, UE #1, may still experience interference from the two most adjacent neighbor UEs, that is, UE #2 and UE #N (closest in the cyclic sense) may be the dominant interfering UEs to UE #1.

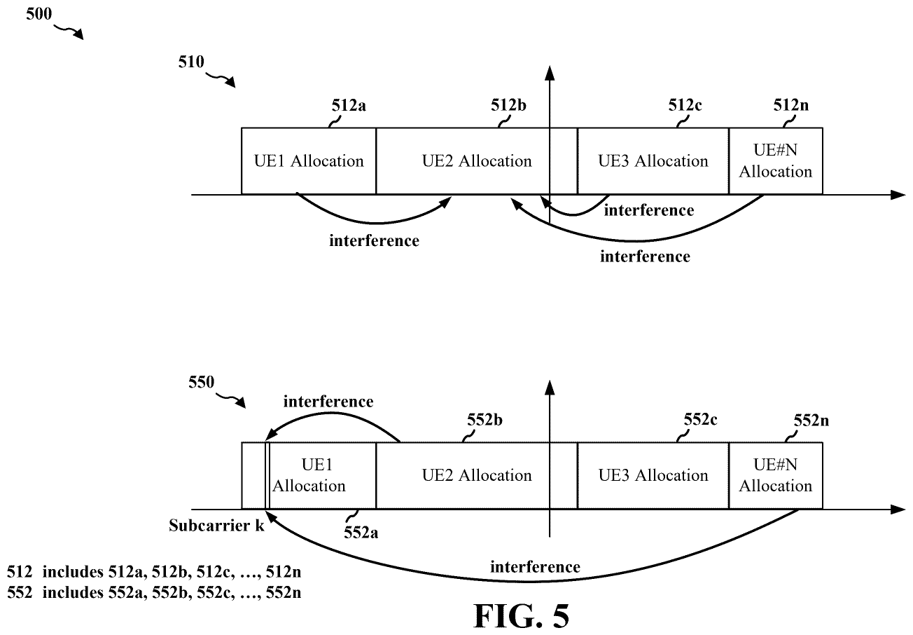

FIG. 5 is a diagram 500 illustrating the ICI from neighbor UEs in connection with FDM. The diagram 510 shows frequency domain allocations 512 including UE1 allocation 512a, UE2 allocation 512b, UE3 allocation 512c, and UE #N allocation 512n. As shown, UE2 may receive interference from all the neighbor UEs of UE2 including UE1, UE3, and UE #N. The diagram 550 shows frequency domain allocations 552 including UE1 allocation 552a, UE2 allocation 552b, UE3 allocation 552c, and UE #N allocation 552n. For the subcarrier k for UE1, the two most dominant interfering UEs may be the UEs whose frequency allocation is the closest (including cyclic closeness) to the subcarrier k, that is, UE2 and UE #N.

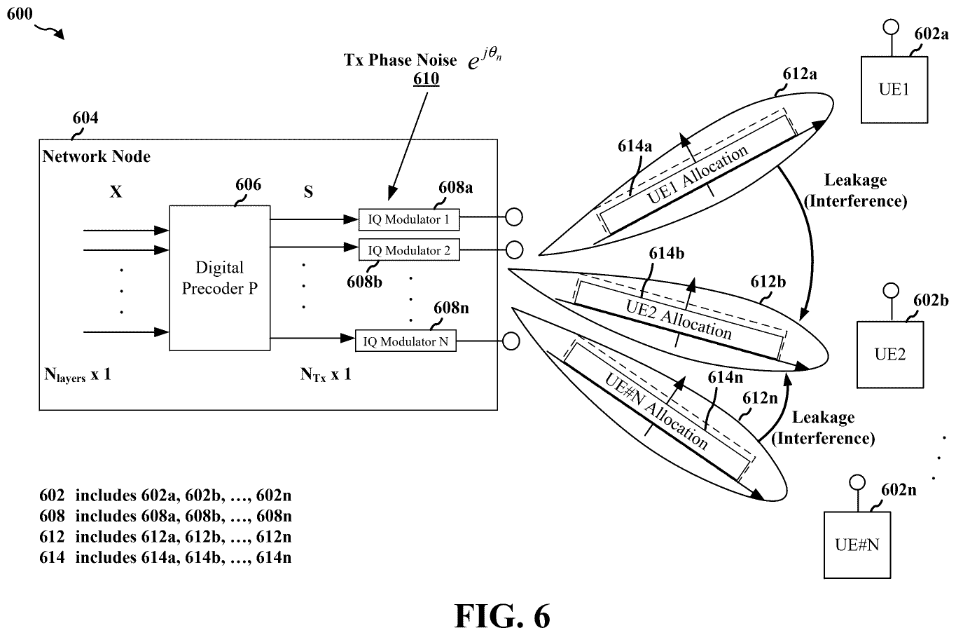

FIG. 6 is a diagram illustrating an example wireless communication system 600 in which multiple UEs are served simultaneously based on SDM. As shown, a network node 604 may serve multiple UEs 602 (including UE1 602a, UE2 602b, . . . , UE #N 602n) over multiple respective beams 612 (including a beam 612a for UE1 602a, a beam 612b for UE2 602b, . . . , a beam 612n for UE #N 602n) using SDM. Each of the UEs 602 may be associated with a respective frequency domain allocation 614 (e.g., UE1 allocation 614a for UE1 602a, UE2 allocation 614b for UE2 602b, . . . , UE #N allocation 614n for UE #N 602n). The frequency domain allocations 614 for different UEs 602 may overlap with each other. The network node 604 may include a digital precoder 606 and a plurality of IQ modulators 608 (i.e., IQ modulator 1 608a, IQ modulator 2 608b, . . . , IQ modulator N 608n). The oscillator at the IQ modulators 608 may introduce the TX phase noise 610.

In some scenarios, the high phase noise may disrupt spatial isolation provided by SDM. In other words, signals for one UE may leak into other UEs. Accordingly, each UE may be impaired not just by the phase noise, but also by the leakage from other UEs. The interference (self-ICI and inter-UE interference) may limit the system performance if left untreated (uncanceled or unmitigated).

For the SDM operation, the network node 604 may precode the data for each UE 502 with a precoder (e.g., the digital precoder 606). The precoding may aim at achieving the maximum gain at the desired UE, while the gain may be nulled at the directions of other non-desired UEs. Therefore, based on the SDM operation, inter-UE leakage may be minimized or eliminated.

For example, UE1 602a may receive the vector of layers x_{1[k]} at the subcarrier k, UE2 602b may receive the vector of layers x_{2[k]} at the subcarrier k, and UE #N may receive the vector of layers x_{N[k]} at the subcarrier k. If no phase noise is present in the transmitter of the network node 604, then the transmitted signal may be S_{[k]}=P_{1[k]}x_{1[k]}+P_{2[k]}x_{2[k]}+ . . . +P_{N[k]}x_{N[k]}. In particular, the maximum number of layers that the network node 604 may support concurrently may be N_{layer}≥length (x₁)+length(x₂)+ . . . +length(x_{N}).

However, due to the phase noise impairment (all TX chains may experience the same phase noise since the oscillator may be shared), the transmitted signal may be S_{[k]}^{(PNimpaired)}=S_{[k]}⊗Iₖ, where the convolution may be per each component of the vector S_{[k]}.

The channel from the network node 604 to a UE #i may be denoted as: Hᵢ: gNb to UEᵢ. Without loss of generality, the received signal at UE1 may be:

$${Y}_{[ k ]} = {H}_{1 [ k ]} \cdot {S}_{[ k ]}^{( P Nimpaired )} = {H}_{1 [ k ]} ( {S}_{[ k ]} ⊗ {I}_{k} ) == {H}_{1 [ k ]} \{ ( {P}_{1 [ k ]} {\underline{x}}_{1 [ k ]} + {P}_{2 [ k ]} {\underline{x}}_{2 [ k ]} + … + {P}_{N [ k ]} {\underline{x}}_{N [ k ]} ) ⊗ {I}_{k} \} == {H}_{1 [ k ]} \{ {\sum }_{r} {I}_{r} {P}_{1 [ k - r ]} {\underline{x}}_{1 [ k - r ]} + {\sum }_{r} {I}_{r} {P}_{2 [ k - r ]} {\underline{x}}_{2 [ k - r ]} + … + {\sum }_{r} {I}_{r} {P}_{N [ k - r ]} {\underline{x}}_{N [ k - r ]} \}$$

The precoders (e.g., the digital precoder 606) may be calculated per subcarrier (or based on a PRG algorithm) so that they may provide the minimal inter-UE interference:

$${H}_{1 [ k ]} {P}_{1 [ k ]} = max energy$$

$${H}_{1 [ k ]} {P}_{j [ k ]} \approx 0 , j \neq 1$$

Therefore, the received signal at UE1 may be: Y_{[k]}≅Σᵣ IᵣH_{1[k]}P_{1[k-r]}x_{1[k-r]}+Σ_{r≠0} Σᵣ IᵣH_{1[k]}P_{2[k-r]}x_{2[k-r]}+ . . . +Σ_{r≠0} IᵣH_{1[k]}P_{N[k-r]}x_{N[k-r]}. The part Σᵣ IᵣH_{1[k]}P_{1[k-r]}x_{1[k-r]} may correspond to the desired signal for the UE of interest (e.g., UE1). The channel H1[k] and the precoder P1[k−r] may not be designed to be orthogonal for subcarrier difference r≠0, yielding ICI (self-ICI) for the UE of interest. Further, all layers (of the UE of interest) may leak into each other from the current subcarrier k and also from adjacent subcarriers.

Moreover, the part Σ_{r≠0} IᵣH_{1[k]}P_{2[k-r]}x_{2[k-r]}+ . . . +Σ_{r≠0} IᵣH_{1[k]}P_{N[k-r]}x_{N[k-r]} may correspond to the inter-UE interference. The channel H1[k] and precoders P2, . . . , PN at neighbor UEs may be orthogonal just for subcarrier difference r=0; however, for the rest of subcarrier differences r≠0, there may not be orthogonality, yielding inter-UE leakage (e.g., UE2, . . . , UE #N leaking into the UE of interest (UE1)).

In one or more aspects, a receiver (receiving apparatus, such as a UE) may perform phase noise estimation and correction, and may remove (cancel) the inter-UE interference if the receiver knows the frequency domain allocation map and the modulation orders of the interfering UEs. In particular, the receiving apparatus may first obtain a coarse estimation of the ICI coefficients

$${\hat{I}}_{r}^{( 0 )}$$

from a known pilot sequence (e.g., a short pilot sequence) in the frequency domain embedded in each symbol (per each UE). Then, the receiving apparatus may apply de-ICI correction to the entire allocation based on the coarse ICI coefficients as follows (based on a simplified example notation of the ICI/inter-UE interference: Zₖ=Xₖ+Σᵣ IᵣXₖ₋ᵣ): For the first iteration:

$${Z}_{c o rrected [ k ]}^{( iteration 0 )} = {Z}_{[ k ]}$$

$${Z}_{corrected [ k ]}^{( iteration 1 )} = {Z}_{[ k ]} - {\sum }_{r} {\hat{I}}_{r}^{( 0 )} \cdot HD ( {Z}_{corrected [ k - r ]}^{( iteration 0 )} , modulation\_order )$$

where

$$HD ( {Z}_{c o rrected [ k - r ]}^{( i t e r ation 0 )} , modulation\_order )$$

may correspond to a hard decision (HD) (the input of a hard decision may be a symbol and the noise, and the output of the hard decision may be a closest symbol (i.e., hard symbol) from a known symbol list) over noisy soft symbols. If the index k−r belongs to the UE of interest, then the hard decision for the modulation order Q_current_UE (modulation order for the UE of interest) (e.g. 1024 QAM) may be applied, whereas if the index k−r belongs to another UE, then the a priori knowledge that this other UE has the modulation order Q_other_UE(s) (e.g. 256 QAM) may be used and the hard decision may be applied accordingly.

Next, the receiving apparatus may refine the ICI estimation by estimating jointly over both the pilots and the tentative hard decisions

$$( e . g . , {Z}_{c o rrected [ k ]}^{( i t e r a tion 1 )} )$$

of the data (data of the UE of interest and of other interfering UEs). The obtained refined ICI estimation may be Îᵣ⁽¹⁾. Thereafter, the receiving apparatus may apply the ICI correction (remove self-ICI interference and interference from other UEs). The receiving apparatus may repeat the above process iteratively with ever more accurate ICI estimates. The iterative process may be given by the formulas below:

$${Z}_{c o rrected [ k ]}^{( i t e r ation i + 1 )} = {Z}_{[ k ]} - {\sum }_{r} {\hat{I}}_{r}^{( i )} \cdot HD ( {Z}_{c o rrected [ k - r ]}^{( i t e r ation i )} , modulation\_order )$$

$${\hat{I}}_{r}^{( i )} = ICI\_estimation \{ ( pilots , HD ( {Z}_{c o rrected [ k ]}^{( i t e r ation i )} , modulation\_order ) \}$$

In some configurations, a UE of interest may decide to reduce the complexity load and refrain from canceling phase noise leakage from other users (UEs). In other words, the UE may refrain from canceling the phase noise-associated inter-UE interference. For example, if the error vector magnitude (EVM) is poor due to the dominance of the thermal noise (e.g., −15 dB) while the phase noise level is not the dominant floor (e.g., −30 dB), then it may not be worthwhile to attempt to remove either the self-ICI or the inter-UE interference caused by the phase noise. The UE may estimate the EVM, which may vary from slot to slot. Accordingly, the UE may decide to remove the phase noise-associated inter-UE interference for slots where the phase noise is the dominant floor, and may decide to refrain from removing the phase noise-associated inter-UE interference for slots where the phase noise is not the dominant floor (e.g., where the EVM is poor due to the dominance of the thermal noise). For example, for slots that have good thermal EVM (e.g., −35 dB), the UE may consider it worthwhile to remove the phase noise-associated inter-UE interference as the phase noise is the dominant floor (e.g., −30 dB). In this example, by removing the phase noise-associated inter-UE interference, the UE may benefit from a total EVM improvement (e.g., from −30 dB to −35 dB). Accordingly, in some aspects, the UE may be capable of separately estimating the EVM due to the thermal noise (e.g., based on pilot subcarriers with null tones around them: As the null tones contain mostly thermal noise with no phase noise, the null tones may be a good source for estimating the EVM caused by the thermal noise).

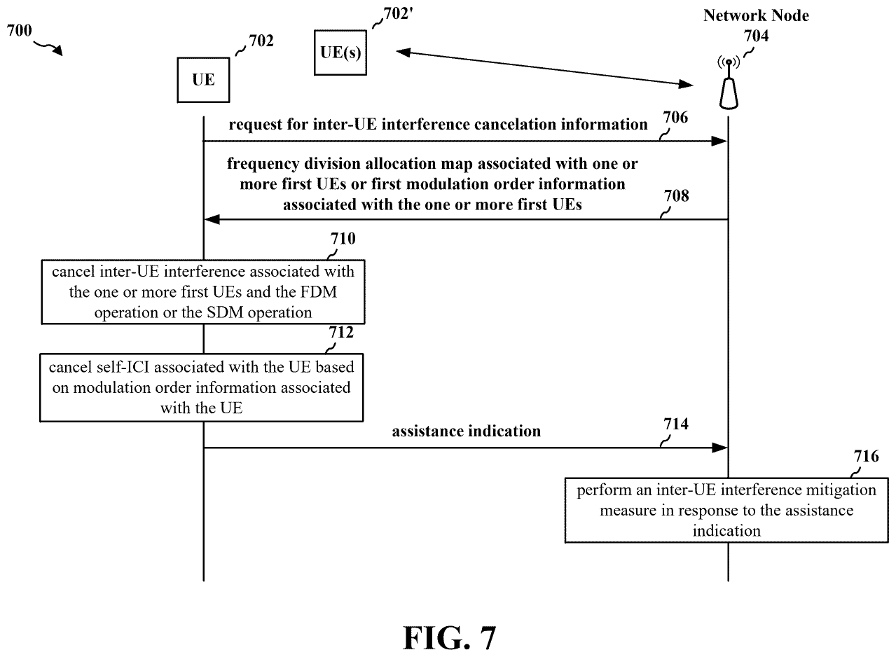

FIG. 7 is a diagram of a communication flow 700 of a method of wireless communication. The UE 702 may implement aspects of the UE 104/350. Further, the network node 704 may implement aspects of the base station 102/310. At 706, the UE 702 may transmit, for the network node 704, a request for inter-UE interference cancelation information.

In one configuration, the UE 702 may transmit, at 706, the request for the inter-UE interference cancelation information via a PUCCH or a PUSCH.

At 708, the network node 704 may transmit a frequency domain allocation map associated with one or more first UEs 702′ or first modulation order information associated with the one or more first UEs 702′ to the UE 702 based on the request for the inter-UE interference cancelation information. The UE 702 and the one or more first UEs 702′ may be associated with an FDM operation or an SDM operation.

In one configuration, the UE 702 and the one or more first UEs 702′ may be associated with at least one same slot based on the FDM operation or the SDM operation. It should be appreciated that if a group of other UEs are served in a different slot (based on either FDM or SDM), then the group of other UEs may not cause interference to the UE of interest.

In one configuration, the network node 704 may transmit, at 708, the frequency domain allocation map associated with the one or more first UEs 702′ or the first modulation order information associated with the one or more first UEs 702′ to the UE 702 via a PDCCH or a PDSCH.

In one configuration, the frequency domain allocation map associated with the one or more first UEs 702′ may include frequency domain allocation information associated with one or more slots. In some configurations, the network node 704 may include indications of slots (e.g., slot numbers) over which the frequency domain allocation information and/or the modulation order information is applicable/relevant. For instance, if slots n, n+1, and n+2 are used to serve a first set of UEs, then the frequency domain allocation information and/or the modulation order information for the first set of UEs is applicable/relevant for slots n, n+1, and n+2. In the same example, similarly, if slots n+3, n+4, and n+5 are used to serve a second set of UEs, then the frequency domain allocation information and/or the modulation order information for the second set of UEs is applicable/relevant for slots n+3, n+4, and n+5 (and not applicable/relevant for slots n, n+1, and n+2).

At 710, the UE 702 may cancel inter-UE interference associated with the one or more first UEs 702′ and the FDM operation or the SDM operation based on the frequency domain allocation map or the first modulation order information. The inter-UE interference may be associated with a phase noise associated with the network node 704.

In one configuration, the phase noise associated with the network node 704 may be associated with an oscillator at the network node 704.

In one configuration, the UE 702 may cancel, at 710, the inter-UE interference based on one or more ICI estimates.

In one configuration, the UE 702 may refine the one or more ICI estimates based on an iterative process, a pilot sequence, and the first modulation order information associated with the one or more first UEs 702′.

At 712, the UE 702 may cancel self-ICI associated with the UE 702 based on modulation order information associated with the UE 702.

At 714, the UE 702 may transmit, for the network node 704, an assistance indication if a residual EVM subsequent to the cancelation of the inter-UE interference is greater than a threshold. In other words, the UE 702 may transmit the assistance indication to the network node 704 if the result of the inter-UE interference cancelation is not satisfactory to the UE 702.

At 716, the network node 704 may perform an inter-UE interference mitigation measure in response to the assistance indication. For example, to perform the inter-UE interference mitigation measure, if FDM is used, the network node 704 may adjust the frequency domain allocations for the neighbor UEs of the UE 702 to provide or increase frequency gaps between the frequency resources allocated to the neighbor UEs and the frequency resources allocated to the UE 702. The frequency gaps may decrease the amount of inter-UE leakage. In another example, if SDM is used, to perform the inter-UE interference mitigation measure, the network node 704 may decrease the overlap percentage between the frequency domain allocation maps of different UEs, while continuing to serve the different UEs on different beams (whereas in pure SDM, a same bandwidth may be used for all UEs and the leakage level may be higher compared to an FDM scenario). In other words, to perform the inter-UE interference mitigation measure, the network node 704 may serve the UEs based on partial FDM while continuing to apply SDM. Falling back from pure SDM to partial FDM in conjunction with SDM may reduce the inter-UE leakage.

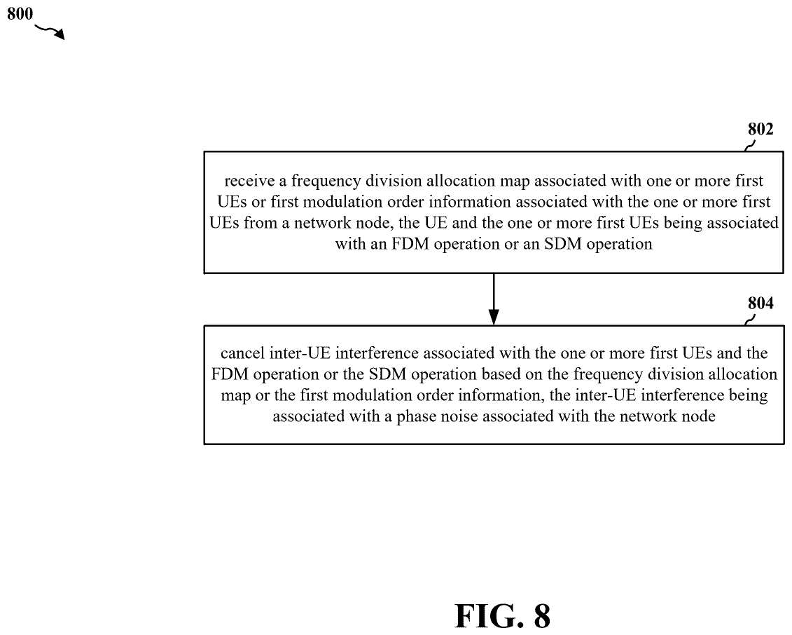

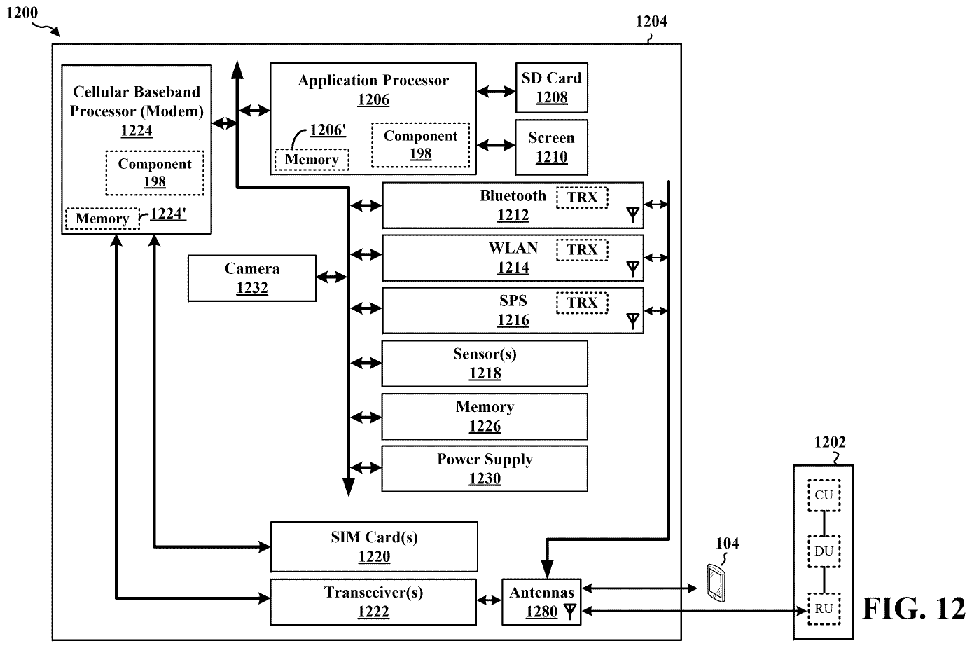

FIG. 8 is a flowchart 800 of a method of wireless communication. The method may be performed by a UE (e.g., the UE 104/350/702; the apparatus 1204). At 802, the UE may receive a frequency domain allocation map associated with one or more first UEs or first modulation order information associated with the one or more first UEs from a network node. The UE and the one or more first UEs may be associated with an FDM operation or an SDM operation. For example, 802 may be performed by the component 198 in FIG. 12. Referring to FIG. 7, at 708, the UE 702 may receive a frequency domain allocation map associated with one or more first UEs 702′ or first modulation order information associated with the one or more first UEs 702′ from a network node 704.

At 804, the UE may cancel inter-UE interference associated with the one or more first UEs and the FDM operation or the SDM operation based on the frequency domain allocation map or the first modulation order information. The inter-UE interference may be associated with a phase noise associated with the network node. For example, 804 may be performed by the component 198 in FIG. 12. Referring to FIG. 7, at 710, the UE 702 may cancel inter-UE interference associated with the one or more first UEs 702′ and the FDM operation or the SDM operation based on the frequency domain allocation map or the first modulation order information.

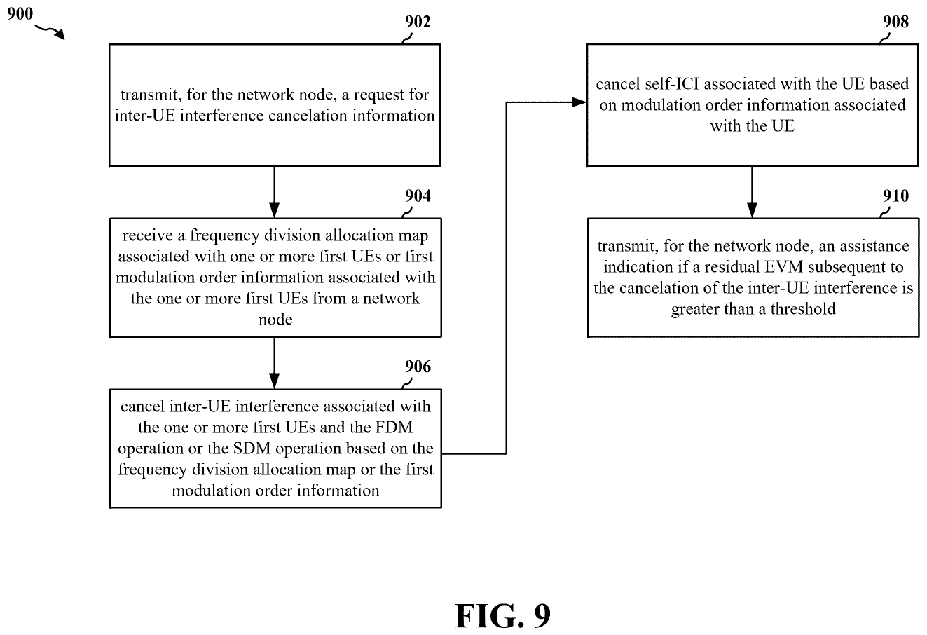

FIG. 9 is a flowchart 900 of a method of wireless communication. The method may be performed by a UE (e.g., the UE 104/350/702; the apparatus 1204). At 904, the UE may receive a frequency domain allocation map associated with one or more first UEs or first modulation order information associated with the one or more first UEs from a network node. The UE and the one or more first UEs may be associated with an FDM operation or an SDM operation. For example, 904 may be performed by the component 198 in FIG. 12. Referring to FIG. 7, at 708, the UE 702 may receive a frequency domain allocation map associated with one or more first UEs 702′ or first modulation order information associated with the one or more first UEs 702′ from a network node 704.

At 906, the UE may cancel inter-UE interference associated with the one or more first UEs and the FDM operation or the SDM operation based on the frequency domain allocation map or the first modulation order information. The inter-UE interference may be associated with a phase noise associated with the network node. For example, 906 may be performed by the component 198 in FIG. 12. Referring to FIG. 7, at 710, the UE 702 may cancel inter-UE interference associated with the one or more first UEs 702′ and the FDM operation or the SDM operation based on the frequency domain allocation map or the first modulation order information.

In one configuration, at 902, the UE may transmit, for the network node, a request for inter-UE interference cancelation information. The frequency domain allocation map or the first modulation order information may be received based on the request for the inter-UE interference cancelation information. For example, 902 may be performed by the component 198 in FIG. 12. Referring to FIG. 7, at 706, the UE 702 may transmit, for the network node 704, a request for inter-UE interference cancelation information.

In one configuration, referring to FIG. 7, the request for the inter-UE interference cancelation information may be transmitted, at 706, via a PUCCH or a PUSCH.

In one configuration, at 908, the UE may cancel self-ICI associated with the UE based on modulation order information associated with the UE. For example, 908 may be performed by the component 198 in FIG. 12. Referring to FIG. 7, at 712, the UE 702 may cancel self-ICI associated with the UE 702 based on modulation order information associated with the UE 702.

In one configuration, referring to FIG. 7, the phase noise associated with the network node 704 may be associated with an oscillator at the network node 704.

In one configuration, referring to FIG. 7, the inter-UE interference may be canceled, at 710, based on one or more ICI estimates.

In one configuration, referring to FIG. 7, the one or more ICI estimates may be refined based on an iterative process, a pilot sequence, and the first modulation order information associated with the one or more first UEs 702′.

In one configuration, referring to FIG. 7, the UE 702 and the one or more first UEs 702′ may be associated with at least one same slot based on the FDM operation or the SDM operation.

In one configuration, referring to FIG. 7, the frequency domain allocation map associated with the one or more first UEs 702′ or the first modulation order information associated with the one or more first UEs 702′ may be received, at 708, via a PDCCH or a PDSCH.

In one configuration, referring to FIG. 7, the frequency domain allocation map associated with one or more first UEs 702′ may include frequency domain allocation information associated with one or more slots.

In one configuration, at 910, the UE may transmit, for the network node, an assistance indication if a residual EVM subsequent to the cancelation of the inter-UE interference is greater than a threshold. For example, 910 may be performed by the component 198 in FIG. 12. Referring to FIG. 7, at 714, the UE 702 may transmit, for the network node 704, an assistance indication if a residual EVM subsequent to the cancelation of the inter-UE interference is greater than a threshold.

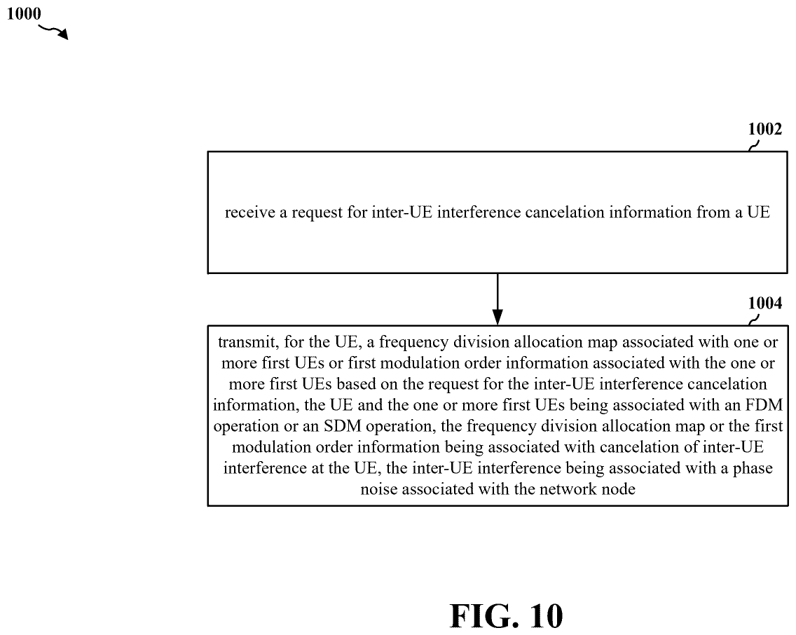

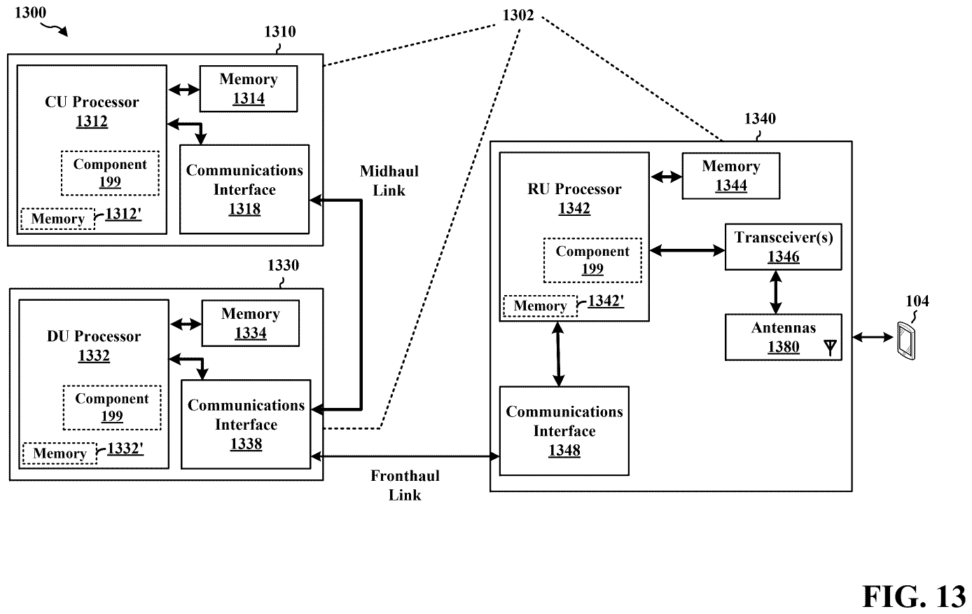

FIG. 10 is a flowchart 1000 of a method of wireless communication. The method may be performed by a network node (e.g., the base station 102/310; the network node 704; the network entity 1202). At 1002, the network node may receive a request for inter-UE interference cancelation information from a UE. For example, 1002 may be performed by the component 199 in FIG. 13. Referring to FIG. 7, at 706, the network node 704 may receive a request for inter-UE interference cancelation information from a UE 702.

At 1004, the network node may transmit, for the UE, a frequency domain allocation map associated with one or more first UEs or first modulation order information associated with the one or more first UEs based on the request for the inter-UE interference cancelation information. The UE and the one or more first UEs may be associated with an FDM operation or an SDM operation. The frequency domain allocation map or the first modulation order information may be associated with cancelation of inter-UE interference at the UE. The inter-UE interference may be associated with a phase noise associated with the network node. For example, 1004 may be performed by the component 199 in FIG. 13. Referring to FIG. 7, at 708, the network node 704 may transmit a frequency domain allocation map associated with one or more first UEs 702′ or first modulation order information associated with the one or more first UEs 702′ to the UE 702 based on the request for the inter-UE interference cancelation information.

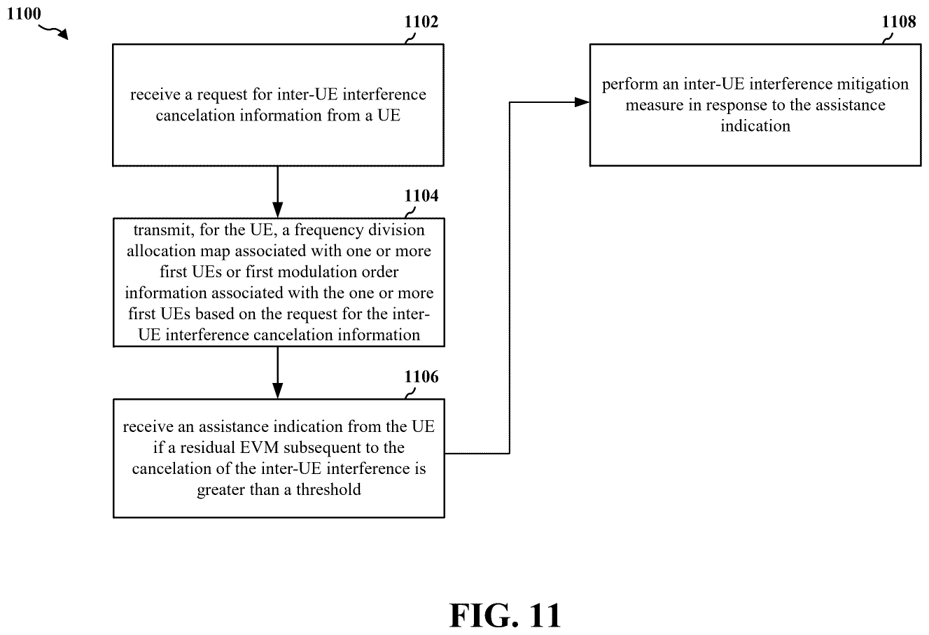

FIG. 11 is a flowchart 1100 of a method of wireless communication. The method may be performed by a network node (e.g., the base station 102/310; the network node 704; the network entity 1202). At 1102, the network node may receive a request for inter-UE interference cancelation information from a UE. For example, 1102 may be performed by the component 199 in FIG. 13. Referring to FIG. 7, at 706, the network node 704 may receive a request for inter-UE interference cancelation information from a UE 702.

At 1104, the network node may transmit, for the UE, a frequency domain allocation map associated with one or more first UEs or first modulation order information associated with the one or more first UEs based on the request for the inter-UE interference cancelation information. The UE and the one or more first UEs may be associated with an FDM operation or an SDM operation. The frequency domain allocation map or the first modulation order information may be associated with cancelation of inter-UE interference at the UE. The inter-UE interference may be associated with a phase noise associated with the network node. For example, 1104 may be performed by the component 199 in FIG. 13. Referring to FIG. 7, at 708, the network node 704 may transmit a frequency domain allocation map associated with one or more first UEs 702′ or first modulation order information associated with the one or more first UEs 702′ to the UE 702 based on the request for the inter-UE interference cancelation information.

In one configuration, referring to FIG. 7, the phase noise associated with the network node 704 may be associated with an oscillator at the network node 704.

In one configuration, referring to FIG. 7, the cancelation of the inter-UE interference at the UE 702 may be based on one or more ICI estimates.

In one configuration, referring to FIG. 7, the one or more ICI estimates may be associated with iterative refinement based on an iterative process, a pilot sequence, and the first modulation order information associated with the one or more first UEs 702′.

In one configuration, referring to FIG. 7, the request for the inter-UE interference cancelation information may be received, at 706, via a PUCCH or a PUSCH.

In one configuration, referring to FIG. 7, the UE 702 and the one or more first UEs 702′ may be associated with at least one same slot based on the FDM operation or the SDM operation.

In one configuration, referring to FIG. 7, the frequency domain allocation map associated with the one or more first UEs 702′ or the first modulation order information associated with the one or more first UEs 702′ may be transmitted, at 708, via a PDCCH or a PDSCH.

In one configuration, referring to FIG. 7, the frequency domain allocation map associated with the one or more first UEs 702′ may include frequency domain allocation information associated with one or more slots.

In one configuration, at 1106, the network node may receive an assistance indication from the UE if a residual EVM subsequent to the cancelation of the inter-UE interference is greater than a threshold. For example, 1106 may be performed by the component 199 in FIG. 13. Referring to FIG. 7, at 714, the network node 704 may receive an assistance indication from the UE 702 if a residual EVM subsequent to the cancelation of the inter-UE interference is greater than a threshold.

At 1108, the network node may perform an inter-UE interference mitigation measure in response to the assistance indication. For example, 1108 may be performed by the component 199 in FIG. 13. Referring to FIG. 7, at 716, the network node 704 may perform an inter-UE interference mitigation measure in response to the assistance indication.

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include a cellular baseband processor 1224 (also referred to as a modem) coupled to one or more transceivers 1222 (e.g., cellular RF transceiver). The cellular baseband processor 1224 may include on-chip memory 1224′. In some aspects, the apparatus 1204 may further include one or more subscriber identity modules (SIM) cards 1220 and an application processor 1206 coupled to a secure digital (SD) card 1208 and a screen 1210. The application processor 1206 may include on-chip memory 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize the antennas 1280 for communication. The cellular baseband processor 1224 communicates through the transceiver(s) 1222 via one or more antennas 1280 with the UE 104 and/or with an RU associated with a network entity 1202. The cellular baseband processor 1224 and the application processor 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor 1224 and the application processor 1206 are each responsible for general processing, including the execution of software stored on the computer-readable medium/memory. The software, when executed by the cellular baseband processor 1224/application processor 1206, causes the cellular baseband processor 1224/application processor 1206 to perform the various functions described supra.

The computer-readable medium/memory may also be used for storing data that is manipulated by the cellular baseband processor 1224/application processor 1206 when executing software. The cellular baseband processor 1224/application processor 1206 may be a component of the UE 350 and may include the memory 360 and/or at least one of the TX processor 368, the RX processor 356, and the controller/processor 359. In one configuration, the apparatus 1204 may be a processor chip (modem and/or application) and include just the cellular baseband processor 1224 and/or the application processor 1206, and in another configuration, the apparatus 1204 may be the entire UE (e.g., see 350 of FIG. 3) and include the additional modules of the apparatus 1204.

As discussed supra, the component 198 is configured to receive a frequency domain allocation map associated with one or more first UEs or first modulation order information associated with the one or more first UEs from a network node. The UE and the one or more first UEs may be associated with an FDM operation or an SDM operation. The component 198 is configured to cancel inter-UE interference associated with the one or more first UEs and the FDM operation or the SDM operation based on the frequency domain allocation map or the first modulation order information. The inter-UE interference may be associated with a phase noise associated with the network node. The component 198 may be within the cellular baseband processor 1224, the application processor 1206, or both the cellular baseband processor 1224 and the application processor 1206. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1204 may include a variety of components configured for various functions. In one configuration, the apparatus 1204, and in particular the cellular baseband processor 1224 and/or the application processor 1206, includes means for receiving a frequency domain allocation map associated with one or more first UEs or first modulation order information associated with the one or more first UEs from a network node. The UE and the one or more first UEs may be associated with an FDM operation or an SDM operation. The apparatus 1204, and in particular the cellular baseband processor 1224 and/or the application processor 1206, includes means for canceling inter-UE interference associated with the one or more first UEs and the FDM operation or the SDM operation based on the frequency domain allocation map or the first modulation order information. The inter-UE interference may be associated with a phase noise associated with the network node.

In one configuration, the apparatus 1204, and in particular the cellular baseband processor 1224 and/or the application processor 1206, includes means for transmitting, for the network node, a request for inter-UE interference cancelation information. The frequency domain allocation map or the first modulation order information may be received based on the request for the inter-UE interference cancelation information. In one configuration, the request for the inter-UE interference cancelation information may be transmitted via a PUCCH or a PUSCH. In one configuration, the apparatus 1204, and in particular the cellular baseband processor 1224 and/or the application processor 1206, includes means for canceling self-ICI associated with the UE based on modulation order information associated with the UE. In one configuration, the phase noise associated with the network node may be associated with an oscillator at the network node. In one configuration, the inter-UE interference may be canceled based on one or more ICI estimates. In one configuration, the one or more ICI estimates may be refined based on an iterative process, a pilot sequence, and the first modulation order information associated with the one or more first UEs. In one configuration, the UE and the one or more first UEs may be associated with at least one same slot based on the FDM operation or the SDM operation. In one configuration, the frequency domain allocation map associated with the one or more first UEs or the first modulation order information associated with the one or more first UEs may be received via a PDCCH or a PDSCH. In one configuration, the frequency domain allocation map associated with the one or more first UEs may include frequency domain allocation information associated with one or more slots. In one configuration, the apparatus 1204, and in particular the cellular baseband processor 1224 and/or the application processor 1206, includes means for transmitting, for the network node, an assistance indication if a residual EVM subsequent to the cancelation of the inter-UE interference is greater than a threshold. The means may be the component 198 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 13 is a diagram 1300 illustrating an example of a hardware implementation for a network entity 1302. The network entity 1302 may be a BS, a component of a BS, or may implement BS functionality. The network entity 1302 may include at least one of a CU 1310, a DU 1330, or an RU 1340. For example, depending on the layer functionality handled by the component 199, the network entity 1302 may include the CU 1310; both the CU 1310 and the DU 1330; each of the CU 1310, the DU 1330, and the RU 1340; the DU 1330; both the DU 1330 and the RU 1340; or the RU 1340. The CU 1310 may include a CU processor 1312. The CU processor 1312 may include on-chip memory 1312′. In some aspects, the CU 1310 may further include additional memory modules 1314 and a communications interface 1318. The CU 1310 communicates with the DU 1330 through a midhaul link, such as an F1 interface. The DU 1330 may include a DU processor 1332. The DU processor 1332 may include on-chip memory 1332′. In some aspects, the DU 1330 may further include additional memory modules 1334 and a communications interface 1338. The DU 1330 communicates with the RU 1340 through a fronthaul link. The RU 1340 may include an RU processor 1342. The RU processor 1342 may include on-chip memory 1342′. In some aspects, the RU 1340 may further include additional memory modules 1344, one or more transceivers 1346, antennas 1380, and a communications interface 1348. The RU 1340 communicates with the UE 104. The on-chip memory 1312′, 1332′, 1342′ and the additional memory modules 1314, 1334, 1344 may each be considered a computer-readable medium/memory. Each computer-readable medium/memory may be non-transitory. Each of the processors 1312, 1332, 1342 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 is configured to receive a request for inter-UE interference cancelation information from a UE. The component 199 is configured to transmit, for the UE, a frequency domain allocation map associated with one or more first UEs or first modulation order information associated with the one or more first UEs based on the request for the inter-UE interference cancelation information.

The UE and the one or more first UEs may be associated with an FDM operation or an SDM operation. The frequency domain allocation map or the first modulation order information may be associated with cancelation of inter-UE interference at the UE. The inter-UE interference may be associated with a phase noise associated with the network node. The component 199 may be within one or more processors of one or more of the CU 1310, DU 1330, and the RU 1340. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1302 may include a variety of components configured for various functions. In one configuration, the network entity 1302 includes means for receiving a request for inter-UE interference cancelation information from a UE. The network entity 1302 includes means for transmitting, for the UE, a frequency domain allocation map associated with one or more first UEs or first modulation order information associated with the one or more first UEs based on the request for the inter-UE interference cancelation information. The UE and the one or more first UEs may be associated with an FDM operation or an SDM operation. The frequency domain allocation map or the first modulation order information may be associated with cancelation of inter-UE interference at the UE. The inter-UE interference may be associated with a phase noise associated with the network node.

In one configuration, the phase noise associated with the network node may be associated with an oscillator at the network node. In one configuration, the cancelation of the inter-UE interference at the UE may be based on one or more ICI estimates. In one configuration, the one or more ICI estimates may be associated with iterative refinement based on an iterative process, a pilot sequence, and the first modulation order information associated with the one or more first UEs. In one configuration, the request for the inter-UE interference cancelation information may be received via a PUCCH or a PUSCH. In one configuration, the UE and the one or more first UEs may be associated with at least one same slot based on the FDM operation or the SDM operation. In one configuration, the frequency domain allocation map associated with the one or more first UEs or the first modulation order information associated with the one or more first UEs may be transmitted via a PDCCH or a PDSCH. In one configuration, the frequency domain allocation map associated with the one or more first UEs may include frequency domain allocation information associated with one or more slots. In one configuration, the network entity 1302 includes means for receiving an assistance indication from the UE if a residual EVM subsequent to the cancelation of the inter-UE interference is greater than a threshold. The network entity 1302 includes means for performing an inter-UE interference mitigation measure in response to the assistance indication.

The means may be the component 199 of the network entity 1302 configured to perform the functions recited by the means. As described supra, the network entity 1302 may include the TX processor 316, the RX processor 370, and the controller/processor 375. As such, in one configuration, the means may be the TX processor 316, the RX processor 370, and/or the controller/processor 375 configured to perform the functions recited by the means.

Referring back to FIGS. 4-13, a network node may transmit a frequency domain allocation map associated with one or more first UEs or first modulation order information associated with the one or more first UEs to a UE. The UE and the one or more first UEs may be associated with an FDM operation or an SDM operation. The UE may cancel inter-UE interference associated with the one or more first UEs and the FDM operation or the SDM operation based on the frequency domain allocation map or the first modulation order information. The inter-UE interference may be associated with a phase noise associated with the network node. Accordingly, a UE may be able to cancel inter-UE interference associated with the network node TX phase noise where an FDM operation or an SDM operation is used. Satisfactory system performance may be achieved, especially at higher carrier frequencies and/or higher modulation order.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a UE, including receiving a frequency domain allocation map associated with one or more first UEs or first modulation order information associated with the one or more first UEs from a network node, the UE and the one or more first UEs being associated with an FDM operation or an SDM operation; and canceling inter-UE interference associated with the one or more first UEs and the FDM operation or the SDM operation based on the frequency domain allocation map or the first modulation order information, the inter-UE interference being associated with a phase noise associated with the network node.
Aspect 2 is the method of aspect 1, further including: transmitting, for the network node, a request for inter-UE interference cancelation information, the frequency domain allocation map or the first modulation order information being received based on the request for the inter-UE interference cancelation information.
Aspect 3 is the method of aspect 2, where the request for the inter-UE interference cancelation information is transmitted via a PUCCH or a PUSCH.
Aspect 4 is the method of any of aspects 1 to 3, further including: canceling self-ICI associated with the UE based on modulation order information associated with the UE.
Aspect 5 is the method of any of aspects 1 to 4, where the phase noise associated with the network node is associated with an oscillator at the network node.
Aspect 6 is the method of any of aspects 1 to 5, where the inter-UE interference is canceled based on one or more ICI estimates.
Aspect 7 is the method of aspect 6, where the one or more ICI estimates are refined based on an iterative process, a pilot sequence, and the first modulation order information associated with the one or more first UEs.
Aspect 8 is the method of any of aspects 1 to 7, where the UE and the one or more first UEs are associated with at least one same slot based on the FDM operation or the SDM operation.
Aspect 9 is the method of any of aspects 1 to 8, where the frequency domain allocation map associated with the one or more first UEs or the first modulation order information associated with the one or more first UEs is received via a PDCCH or a PDSCH.
Aspect 10 is the method of any of aspects 1 to 9, where the frequency domain allocation map associated with the one or more first UEs includes frequency domain allocation information associated with one or more slots.
Aspect 11 is the method of any of aspects 1 to 10, further including: transmitting, for the network node, an assistance indication if a residual EVM subsequent to the cancelation of the inter-UE interference is greater than a threshold.
Aspect 12 is a method of wireless communication at a network node, including receive a request for inter-UE interference cancelation information from a UE; and transmit, for the UE, a frequency domain allocation map associated with one or more first UEs or first modulation order information associated with the one or more first UEs based on the request for the inter-UE interference cancelation information, the UE and the one or more first UEs being associated with an FDM operation or an SDM operation, the frequency domain allocation map or the first modulation order information being associated with cancelation of inter-UE interference at the UE, the inter-UE interference being associated with a phase noise associated with the network node.
Aspect 13 is the method of aspect 12, where the phase noise associated with the network node is associated with an oscillator at the network node.
Aspect 14 is the method of any of aspects 12 and 13, where the cancelation of the inter-UE interference at the UE is based on one or more ICI estimates.
Aspect 15 is the method of aspect 14, where the one or more ICI estimates are associated with iterative refinement based on an iterative process, a pilot sequence, and the first modulation order information associated with the one or more first UEs.
Aspect 16 is the method of any of aspects 12 to 15, where the request for the inter-UE interference cancelation information is received via a PUCCH or a PUSCH.
Aspect 17 is the method of any of aspects 12 to 16, where the UE and the one or more first UEs are associated with at least one same slot based on the FDM operation or the SDM operation.
Aspect 18 is the method of any of aspects 12 to 17, where the frequency domain allocation map associated with the one or more first UEs or the first modulation order information associated with the one or more first UEs is transmitted via a PDCCH or a PDSCH.
Aspect 19 is the method of any of aspects 12 to 18, where the frequency domain allocation map associated with the one or more first UEs includes frequency domain allocation information associated with one or more slots.
Aspect 20 is the method of any of aspects 12 to 19, further including: receiving an assistance indication from the UE if a residual EVM subsequent to the cancelation of the inter-UE interference is greater than a threshold; and performing an inter-UE interference mitigation measure in response to the assistance indication.
Aspect 21 is an apparatus for wireless communication including at least one processor coupled to a memory and, based at least in part on information stored in the memory, the at least one processor is configured to implement a method as in any of aspects 1 to 20.
Aspect 22 may be combined with aspect 21 and further includes a transceiver coupled to the at least one processor.
Aspect 23 is an apparatus for wireless communication including means for implementing any of aspects 1 to 20.
Aspect 24 is a non-transitory computer-readable storage medium storing computer executable code, where the code when executed by a processor causes the processor to implement any of aspects 1 to 20.

Various aspects have been described herein. These and other aspects are within the scope of the following claims.

1. An apparatus for wireless communication at a user equipment (UE), comprising: a memory; and
at least one processor coupled to the memory and, based at least in part on information stored in the memory, the at least one processor is configured to:
receive a frequency domain allocation map associated with one or more first UEs or first modulation order information associated with the one or more first UEs from a network node, the UE and the one or more first UEs being associated with a frequency division multiplexing (FDM) operation or a spatial division multiplexing (SDM) operation; and
cancel inter-UE interference associated with the one or more first UEs and the FDM operation or the SDM operation based on the frequency domain allocation map or the first modulation order information, the inter-UE interference being associated with a phase noise associated with the network node.

2. The apparatus of claim 1, the at least one processor being further configured to:
transmit, for the network node, a request for inter-UE interference cancelation information, the frequency domain allocation map or the first modulation order information being received based on the request for the inter-UE interference cancelation information.

3. The apparatus of claim 2, wherein the request for the inter-UE interference cancelation information is transmitted via a physical uplink control channel (PUCCH) or a physical uplink shared channel (PUSCH).

4. The apparatus of claim 1, the at least one processor being further configured to:
cancel self-inter-carrier interference (self-ICI) associated with the UE based on modulation order information associated with the UE.

5. The apparatus of claim 1, wherein the phase noise associated with the network node is associated with an oscillator at the network node.

6. The apparatus of claim 1, wherein the inter-UE interference is canceled based on one or more inter-carrier interference (ICI) estimates.

7. The apparatus of claim 6, wherein the one or more ICI estimates are refined based on an iterative process, a pilot sequence, and the first modulation order information associated with the one or more first UEs.

8. The apparatus of claim 1, wherein the UE and the one or more first UEs are associated with at least one same slot based on the FDM operation or the SDM operation.

9. The apparatus of claim 1, wherein the frequency domain allocation map associated with the one or more first UEs or the first modulation order information associated with the one or more first UEs is received via a physical downlink control channel (PDCCH) or a physical downlink shared channel (PDSCH).

10. The apparatus of claim 1, wherein the frequency domain allocation map associated with the one or more first UEs includes frequency domain allocation information associated with one or more slots.

11. The apparatus of claim 1, the at least one processor being further configured to: transmit, for the network node, an assistance indication if a residual error vector magnitude (EVM) subsequent to the cancelation of the inter-UE interference is greater than a threshold.

12. The apparatus of claim 1, further comprising a transceiver coupled to the at least one processor, the transceiver being configured to receive the frequency domain allocation map associated with the one or more first UEs or the first modulation order information associated with the one or more first UEs.

13. A method of wireless communication at a user equipment (UE), comprising
receiving a frequency domain allocation map associated with one or more first UEs or first modulation order information associated with the one or more first UEs from a network node, the UE and the one or more first UEs being associated with a frequency division multiplexing (FDM) operation or a spatial division multiplexing (SDM) operation; and
canceling inter-UE interference associated with the one or more first UEs and the FDM operation or the SDM operation based on the frequency domain allocation map or the first modulation order information, the inter-UE interference being associated with a phase noise associated with the network node.

14. The method of claim 13, further comprising:
transmitting, for the network node, a request for inter-UE interference cancelation information, the frequency domain allocation map or the first modulation order information being received based on the request for the inter-UE interference cancelation information.

15. The method of claim 14, wherein the request for the inter-UE interference cancelation information is transmitted via a physical uplink control channel (PUCCH) or a physical uplink shared channel (PUSCH).

16. An apparatus for wireless communication at a network node, comprising:
a memory; and
at least one processor coupled to the memory and, based at least in part on information stored in the memory, the at least one processor is configured to:
receive a request for inter-UE interference cancelation information from a user equipment (UE); and
transmit, for the UE, a frequency domain allocation map associated with one or more first UEs or first modulation order information associated with the one or more first UEs based on the request for the inter-UE interference cancelation information, the UE and the one or more first UEs being associated with a frequency division multiplexing (FDM) operation or a spatial division multiplexing (SDM) operation, the frequency domain allocation map or the first modulation order information being associated with cancelation of inter-UE interference at the UE, the inter-UE interference being associated with a phase noise associated with the network node.

17. The apparatus of claim 16, wherein the phase noise associated with the network node is associated with an oscillator at the network node.

18. The apparatus of claim 16, wherein the cancelation of the inter-UE interference at the UE is based on one or more inter-carrier interference (ICI) estimates.

19. The apparatus of claim 18, wherein the one or more ICI estimates are associated with iterative refinement based on an iterative process, a pilot sequence, and the first modulation order information associated with the one or more first UEs.

20. The apparatus of claim 16, wherein the request for the inter-UE interference cancelation information is received via a physical uplink control channel (PUCCH) or a physical uplink shared channel (PUSCH).

21-30. (canceled)
